(19) United States
(12) Patent Application Publication
(10) Pub. No.: US 2006/0259649 A1
(43) Pub. Date: Nov. 16, 2006

(54) INTERFACE SWITCHING APPARATUS AND METHOD

(76) Inventors: Kuan-Hong Hsieh, Shenzhen (CN); Xiao-Guang Li, Shenzhen (CN); Shin-Hong Chung, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,736

(22) Filed: Apr. 27, 2006

(30) Foreign Application Priority Data
May 13, 2005 (CN) 200510034657.0

(51) Int. Cl. G06F 3/00

(52) U.S. Cl. 710/8

(57) ABSTRACT

An interface switching apparatus (40) switches to receive input from a plurality of electronic devices. In an exemplary embodiment, the apparatus includes a receiving unit (44) equipped with a plurality of input ports (441), each for connecting with an electronic device; a detecting unit (45) for detecting new input from any of the input ports; a switching unit (47) for switching the interface switching apparatus so that the interface switching apparatus halts receiving current input from one of the input ports and receives new input from another input port detected to have the new input; a signal converting unit (48) for converting the new input into an information signal having a format that can be received by a display device (30), and an output port (491) for transmitting the information signal to the display device. Related methods are also provided.

### FIELD OF THE INVENTION

The present invention relates to peripheral apparatuses of display devices, and particularly to an interface switching apparatus which can switch to receive input from any of a plurality of electronic devices.

### DESCRIPTION OF RELATED ART

Display devices are widely used in applications such as displays for computers and televisions in the home. Computer displays and home televisions have an advantage over many other electronic devices, as they usually have a large screen to display images originally received in the form of video signals. This enables users to view pictures and information more clearly. In addition, many kinds of audio/video signal recording apparatuses, storing apparatuses, and playing apparatuses have been developed. These apparatuses include VCD (Video Compact Disk) players, DVD (Digital Versatile Disc) players, digital cameras, digital video cameras, MP3 (MPEG Audio Layer3) players, and cell phones.

user may sometimes need to connect one or more electronic devices with a display device in order to obtain a clear view and/or clear listening of information output by the electronic devices. Further, the user may also need to switch between respective of these electronic devices. For example, the user may intend to firstly view information provided by a digital camera via the display device, and subsequently view information provided by a VCD player via the display device. Previously, the user had to first manually disconnect the digital camera from the display device, and then manually connect the VCD player with the display device. In more recent display devices, a switching system is commonly provided. In these display devices, the digital camera and the VCD player are both connected to the display device through respective ports thereof. The switching system enables the user to switch between the digital camera and the VCD player by sending a control signal via a user interface of the display device. However, this switching still requires manual operation of the user interface.

Therefore, there is a need for an interface switching apparatus which can automatically switch between inputs and release the user from having to perform manual operation.

### SUMMARY OF THE INVENTION

An interface switching apparatus in accordance with preferred embodiments is provided. The interface switching apparatus in a first embodiment includes: a plurality of input ports, each for connecting with a respective electronic device; a detecting unit for detecting any new input of any of the input ports; a switching unit for switching the interface switching apparatus so that the interface switching apparatus halts receiving current input from one of the input ports and receives new input from another input port detected to have the new input; and an output port for transmitting the new input to an output device.

In a second embodiment, a controlling unit is also provided, the controlling is mainly for determining a preferred new-input input port according to two or more new inputs received from two or more of the input ports respectively. The switching unit is under control of the controlling unit and is mainly for switching the interface switching apparatus so that the interface switching apparatus receives new input from the preferred new-input input port under control of the controlling unit. The output port is for transmitting the new input from the preferred new-input port to an output device.

In a third embodiment, the controlling unit is mainly for determining a preferred one of the input ports according to one or more new inputs received from one or more of the input ports respectively and according to a current input if any being received from one of the input ports. The switching unit is for switching the interface switching apparatus so that the interface switching apparatus receives new input from the preferred input port, or maintaining a current input of the interface switching apparatus if the interface switching apparatus is already receiving current input from the preferred input port. And the output port is for transmitting the input from the preferred input port to an output device.

An interface switching method in accordance with other preferred embodiments is also provided. The method in a first embodiment mainly includes the steps of: a) detecting any new input of any of a plurality of input ports; b) halting receiving current input from one of the input ports and switching to receive new input from another input port having new input; and d) transmitting the new input to an output device.

In a second embodiment, steps b), c) and d) are respectively replaced by steps b1), c1) and d1) detailed below. Step b1) is: determining a preferred new-input input port according to two or more new inputs received from two or more of the input ports respectively. Step c1) is: switching to receive new input from the preferred new-input input port. Step d1) is: transmitting the new input from the preferred new-input input port to an output device.

In a third embodiment, steps b), c) and d) are respectively replaced by steps b2), c2) and d2) detailed below. Step b2) is: determining a preferred input port according to one or more new inputs received from one or more of the input ports respectively and according to a current input if any being received from one of the input ports. Step c2) is: switching to receive new input from the preferred input port; or if a current input is being received from one of the input ports and said one of the input port is the preferred input port, maintaining the current input. Step d2) is: transmitting the new input or the current input if any received from the preferred input port to an output device.

Other advantages and novel features will be drawn from the following detailed description with reference to the attached drawings, in which:

### BRIEF DESCRIPTION OF THE DRAWINGS

FIG. 1 is a block diagram of an interface switching apparatus in accordance with a preferred embodiment of the present invention, the interface switching apparatus being connected with a display device and a power supply unit; and

FIG. 2 is a flowchart of an exemplary interface switching method in accordance with another preferred embodiment of the present invention.

### DETAILED DESCRIPTION OF THE INVENTION

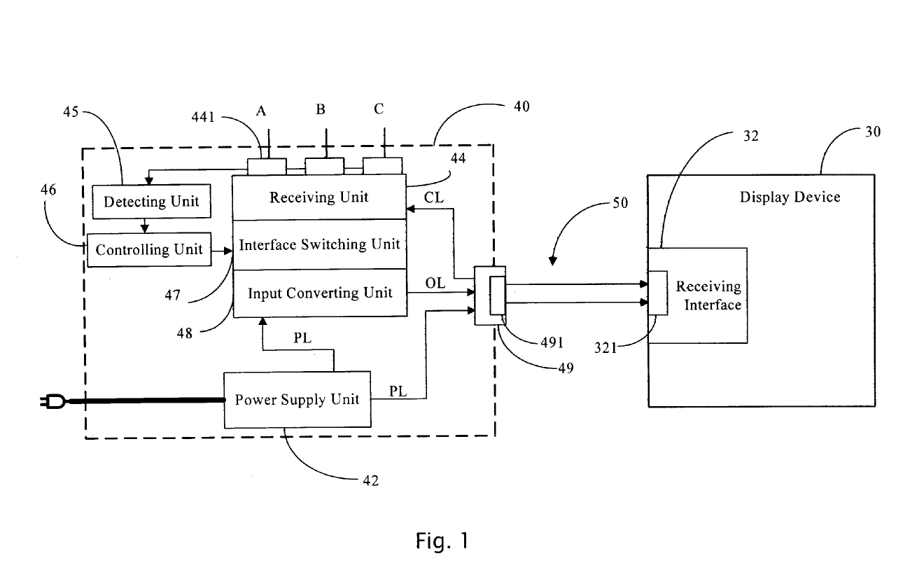

Referring to FIG. 1, this shows an interface switching apparatus 40 in accordance with a preferred embodiment of the present invention. The interface switching apparatus 40 connects with a display device 30. The interface switching apparatus 40 and the display device 30 both receive electric power from a power supply unit 42 via one or more power lines symbolically shown as PL. The power supply unit 42 and the interface switching apparatus 40 may alternatively be integrated in a single apparatus (as shown by a dashed rectangle in FIG. 1). The interface switching apparatus 40 includes a transmitting unit 49. The transmitting unit 49 includes an output port 491. The output port 491 communicates with a receiving port 321 included in a receiving interface 32 of the display device 30, such communication being via a transmission channel 50.

The interface switching apparatus 40 further includes a receiving unit 44, a detecting unit 45, a controlling unit 46, an interface switching unit 47, and an input converting unit 48. The receiving unit 44 is equipped with a plurality of input ports 441 (symbolically shown as A, B, C in the illustrated embodiment). Each of the input ports 441 connects with a respective external electronic device (not shown) to receive input therefrom. That is, typically, a plurality of external electronic devices is connected with the input ports 441 at any one time. The external electronic devices may for example each provide video input, audio input, combined video and audio input, or another kind of input as desired. The description herein is in respect of the display device 30, in which case the external electronic devices typically provide video input or combined video and audio input. However, the display device 30 may be adapted to be able to also provide audio output only, in which case the external electronic devices may provide any combination of video input, audio input, and/or combined video and audio input.

The detecting unit 45 of the interface switching apparatus 40 detects a change from a non-input status to an input status (hereinafter referred to as “new input”) of each input port 441, and informs the controlling unit 46 when the new input of any particular input port 441 is detected. Typically, this occurs in either of the following two circumstances: (1) all of the input ports 441 are in the non-input status at the time when the new input of the particular input port 441 is detected; or (2) one of the input ports 441 is in the input status at the time when the new input of the particular input port 441 is detected. In the following description, unless the context indicates otherwise, it is assumed that new input occurs at the particular input port 441 at the time when the corresponding external electronic device already connected with the particular input port 441 is switched on, either by a user or by other means.

In typical operation of the interface switching apparatus 40, the controlling unit 46 receives the information from the detecting unit 45, identifies the particular input port 441, and produces an interface switching control signal (hereinafter referred to as “a/the control signal”). The control signal is input to the interface switching unit 47. Then the interface switching unit 47 accordingly switches to receive the input from the particular input port 441. The input is then transmitted to the input converting unit 48. The input converting unit 48 converts the input into an information signal having a format that can be received by the receiving port 321 of the display device 30. The information signal is then transmitted to the receiving port 321 of the display device 30 via a signal line symbolically shown as OL and the transmission channel 50.

The receiving unit 44 also receives commands from the display device 30 via the transmission channel 50 and a control line symbolically shown as CL. The commands together with the input are transmitted from the receiving unit 44 to the input converting unit 48. The commands are used in the input converting unit 48 to control the format conversion of the input. According to the commands, the interface switching apparatus 40 identifies what signal format is receivable by the receiving port 321 of the display device 30, and converts the input into the receivable signal format.

The output port 491 of the interface switching apparatus 40 is preferably of the same type as the receiving port 321, so that the transmission channel 50 need only include a power line PL, a signal line OL, and a control line CL. Each of these lines is used to carry a corresponding transmission; i.e., electrical power, information signals, and commands. The transmission channel 50 can alternatively be a single conducting line. In such case, the single conducting line carries compound signals containing electrical power, information signals, and commands. In this description, it should be noted that the power line PL, the signal line OL, the control line CL, and the conducting line are not to be construed as being limited to any specific form. These lines may be configured as desired in order to achieve their respective functions. That is, the power line PL can be of any form as long as it achieves power transfer. The signal line OL can be of any form as long as it achieves information signal transmission. The control line CL can be of any form as long as it achieves command transmission. The conducting line can be of any form as long as it achieves power transfer, information signal transmission, and command transmission.

The detecting unit 45 detects any new input from any of the input ports 441. Each time one of the input ports 441 has new input, a voltage of that particular input port 441 is changed from a low level to a high level. The detecting unit 45 detects the new input by virtue of the voltage change of the particular input port 441, and informs the controlling unit 46 of the new input of the particular input port 441. In the preferred embodiment, the input ports 441 are pre-assigned with an identification (“ID”). The controlling unit 46 recognizes the ID information from the information provided by the detecting unit 45. The controlling unit 46 then produces a control signal containing the ID information. The control signal is transmitted to the interface switching unit 47. The interface switching unit 47 recognizes the ID information in the control signal, and switches to receive the new input of the particular input port 441. This is the most basic embodiment of operation of the interface switching apparatus 40.

In other embodiments of operation of the interface switching apparatus 40, the ID information of the input ports 441 can also used to identify a priority ranking of the input ports 441. The priority ranking is preset and stored in the interface switching apparatus 40. The priority ranking is used by the controlling unit 46 to determine which input port 441 is preferred, typically in any of the following three situations. In a first situation, the interface switching apparatus 40 is already receiving input from one input port 441 at the time new input is detected at another input port 441. In a second situation, new input is detected at two or more input ports 441 at the same time, and the interface switching apparatus 40 is not currently receiving input from another one of the input ports 441 at this time. In a third situation, new input is detected at two or more input ports 441 at the same time, and the interface switching apparatus 40 is currently receiving input from another one of the input ports 441 at this time. In the preferred embodiment, each input port 441 has a different priority ranking, with no two input ports 441 having a same priority ranking.

In an example of the first situation, input port C is detected to have new input at a time when input port A is already transmitting input to the interface switching unit 47 of the interface switching apparatus 40. If input port C has priority over input port A in the priority ranking, the controlling unit 46 transmits a control signal that contains the ID information of input port C to the interface switching unit 47. The interface switching unit 47 recognizes the ID information and switches to receive the new input of input port C. That is, the interface switching unit 47 halts reception of input from input port A, and starts receiving input from input port C. If input port C has a lower priority than input port A, the controlling unit 46 may respond in either of the two following ways, according to the manner in which the controlling unit 46 is configured. In a first kind of response, the controlling unit 46 does not generate any control signal at all. Thus the interface switching unit 47 continues to receive input from input port A according to a control signal previously transmitted by the controlling unit 46, even though there is new input detected at input port C. In a second kind of response, the controlling unit 46 transmits a new control signal that contains the ID information of input port A, and the interface switching unit 47 thus continues to receive input from input port A in accordance with the new control signal, even though there is new input detected at input port C.

In an example of the second situation, if both input ports B and C are detected to have new input simultaneously, and input port C has priority over input port B in the priority ranking, then the controlling unit 46 transmits a control signal that contains the ID information of input port C to the interface switching unit 47. The interface switching unit 47 recognizes the ID information and switches to receive the new input of input port C.

In an example of the third situation, the interface switching apparatus 40 is already receiving input from input port A at the time new input is detected at both input ports B and C simultaneously. In one embodiment of the third situation, the switching in accordance with the control signal is performed regardless of the priority ranking of input port A. Therefore if input port C has priority over input port B, the interface switching unit 47 halts reception of input from input port A, and starts receiving input from input port C. In another embodiment of the third situation, the switching in accordance with the control signal is performed only when input port C has priority over input port A according to the priority ranking. If input port C has a lower priority than input port A, the controlling unit 46 may respond in either of the two following ways, according to the manner in which the controlling unit 46 is configured. In a first kind of response, the controlling unit 46 does not generate any control signal at all. Thus the interface switching unit 47 continues to receive input from input port A according to a control signal previously transmitted by the controlling unit 46, even though there is new input detected at input port C. In a second kind of response, the controlling unit 46 transmits a new control signal that contains the ID information of input port A, and the interface switching unit 47 thus continues to receive input from input port A in accordance with the new control signal, even though there is new input detected at input port C.

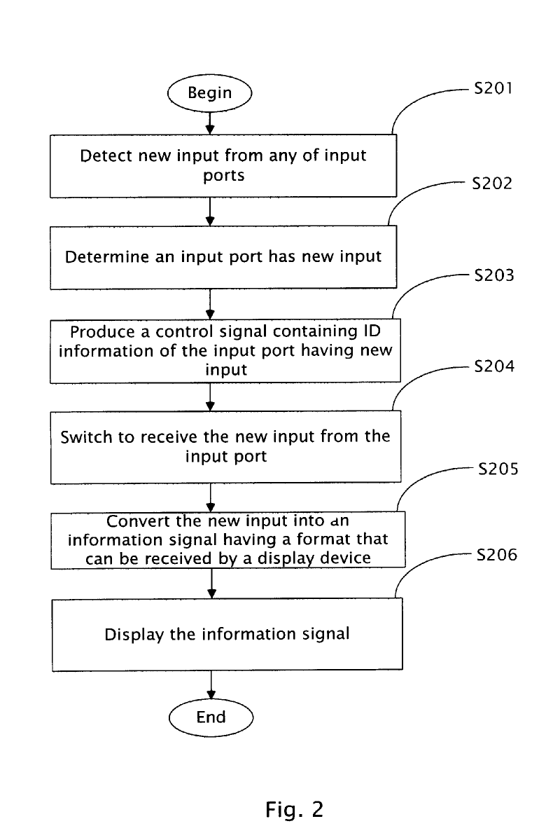

Referring to FIG. 2, this is a flowchart of an exemplary interface switching method in accordance with another embodiment of the present invention. In the exemplary method, the interface switching unit 47 is described as switching from receiving input from input port A to receiving input from input port C.

Step S201: the detecting unit 45 detects any new input from any of the input ports 441. In particular, the detecting unit 45 detects whether a voltage change from a low level to a high level occurs at any of the input ports 441. Such detection may be by way of suitable passive means or suitable active means such as monitoring or scanning.

Step S202: the detecting unit 45 determines that input port C has new input, and informs the controlling unit 46.

Step S203: the controlling unit 46 identifies the ID information of input port C, produces a control signal containing the ID information, and transmits the control signal to the interface switching unit 47.

Step S204: the interface switching unit 47 receives the control signal, recognizes the ID information, and switches to receive the new input from input port C. That is, the interface switching unit 47 receives input from input port C instead of from input port A.

Step S205: the interface switching unit 47 transmits the new input from input port C to the input converting unit 48, and the input converting unit 48 converts the new input to an information signal having a format that can be received by the receiving port 321 of the display unit 30.

Step S206: the display device 30 receives the information signal, and displays (and/or broadcasts) the information signal.

As described above, a priority ranking of the input ports 441 can be preset. This can be done according to a user's particular preferences. Thus when more than one input port 441 has new input at one time, the controlling unit 46 can automatically determine which new-input input port 441 is preferred according to the priority ranking. Further, if the interface switching apparatus 40 is currently receiving input from another input port 441 at the time the new inputs are received, the controlling unit 46 can automatically determine which of all the input ports 441 is preferred according to the priority ranking.

In the above description, the interface switching apparatus 40 connects with the display device 30. However, the principles of the invention herein are equally applicable to the interface switching apparatus 40 connecting with any other kind of desired output device, including but not limited to an audio output device.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An interface switching apparatus, comprising:
a plurality of input ports, each for connecting with a respective electronic device;
a detecting unit for detecting any new input of any of the input ports;
a switching unit for switching the interface switching apparatus so that the interface switching apparatus halts receiving current input from one of the input ports and receives new input from another input port detected to have the new input; and
an output port for transmitting the new input to an output device.

2. The interface switching apparatus as claimed in claim 1, further comprising an input converting unit for converting the new input to an information signal having a format that can be received by the output device.

3. An interface switching apparatus, comprising:
a plurality of input ports, each for connecting with a respective electronic device;
a detecting unit for detecting any new input of any of the input ports;
a controlling unit for determining a preferred new-input input port according to two or more new inputs received from two or more of the input ports respectively;
a switching unit under control of the controlling unit, for switching the interface switching apparatus so that the interface switching apparatus receives new input from the preferred new-input port; and
an output port for transmitting the new input from the preferred new-input port to an output device.

4. The interface switching apparatus as claimed in claim 3, further comprising an input converting unit for converting the new input from the preferred new-input input port to an information signal having a format that can be received by the output device.

5. The interface switching apparatus as claimed in claim 3, wherein the input ports are pre-ranked in order of preference of input they respectively provide.

6. The interface switching apparatus as claimed in claim 5, wherein when two or more of the input ports have new input at the one time, the controlling unit determines the preferred new-input input port according to which of the new-input input ports has the higher/highest rank.

7. An interface switching apparatus, comprising:
a plurality of input ports, each for connecting with a respective electronic device;
a detecting unit for detecting any new input of any of the input ports;
a controlling unit for determining a preferred one of the input ports according to one or more new inputs received from one or more of the input ports respectively and according to a current input if any being received from one of the input ports;
a switching unit under control of the controlling unit, for switching the interface switching apparatus so that the interface switching apparatus receives new input from the preferred input port, or maintaining a current input of the interface switching apparatus if the interface switching apparatus is already receiving current input from the preferred input port; and
an output port for transmitting the input from the preferred input port to an output device.

8. The interface switching apparatus as claimed in claim 7, further comprising an input converting unit for converting the input from the preferred input port to an information signal having a format that can be received by the output device.

9. The interface switching apparatus as claimed in claim 7, wherein the input ports are pre-ranked in order of preference of input they respectively provide.

10. The interface switching apparatus as claimed in claim 9, wherein when one of the input ports has new input when the interface switching apparatus is already receiving current input from another one of the input ports, the controlling unit determines the preferred input port according to which of the new-input input port and the current-input input port has the higher rank; and when two or more of the input ports have new input at the one time, the controlling unit determines the preferred input port according to which of the new-input input ports and a current-input input port if any has the higher/highest rank.

11. An interface switching method, the method comprising:
detecting any new input of any of a plurality of input ports;
halting receiving current input from one of the input ports, and switching to receive new input from another input port having the new input; and
transmitting the new input to an output device.

12. The interface switching method as claimed in claim 11, further comprising the step of converting the new input to an information signal of a format that can be received by the output device.

13. An interface switching method, the method comprising:
detecting any new input of any of a plurality of input ports;
determining a preferred new-input input port according to two or more new inputs received from two or more of the input ports respectively;
switching to receive new input from the preferred new-input input port; and
transmitting the new input from the preferred new-input input port to an output device.

14. The interface switching method as claimed in claim 13, further comprising the step of converting the new input from the preferred new-input input port to an information signal of a format that can be received by the output device.

15. The interface switching method as claimed in claim 13, wherein the input ports are pre-ranked in order of preference of input they respectively provide.

16. The interface switching method as claimed in claim 15, wherein when two or more of the input ports have new input at the one time, the preferred new-input input port is determined according to which of the new-input input ports has the highest rank.

17. An interface switching method, the method comprising:
detecting any new input of any of a plurality of input ports;
determining a preferred input port according to one or more new inputs received from one or more of the input ports respectively and according to a current input if any being received from one of the input ports;
switching to receive new input from the preferred input port; or if a current input is being received from one of the input ports and said one of the input ports is the preferred input port, maintaining the current input; and
transmitting the new input or the current input if any received from the preferred input port to an output device.

18. The interface switching method as claimed in claim 17, further comprising the step of converting the current input if any received or the new input received to an information signal having a format that can be received by the output device.

19. The interface switching method as claimed in claim 17, wherein the input ports are pre-ranked in order of preference of input they respectively provide.

20. The interface switching method as claimed in claim 19, wherein when one of the input ports has new input when current input is already being received from another one of the input ports, the preferred input port is determined according to which of the new-input input port and the current-input input port has the higher rank; and when two or more of the input ports have new input at the one time, the preferred input port is determined according to which of the new-input input ports and a current-input input port if any has the higher/highest rank.
